(19) United States
(12) Patent Application Publication
(10) Pub. No.: US 2022/0292662 A1
(43) Pub. Date: Sep. 15, 2022

(54) INFORMATION PROCESSING APPARATUS,INFORMATION PROCESSING METHOD,AND NON-TRANSITORY COMPUTER-READABLE STORAGE MEDIUM

(71) Applicant: CANON KABUSHIKI KAISHA, Tokyo (JP)

(72) Inventor: Shinichi Mitsumoto, Saitama (JP)

(21) Appl. No.: 17/692,495

(22) Filed: Mar. 11, 2022

(30) Foreign Application Priority Data
Mar. 12, 2021 (JP) 2021-040480

(51) Int. Cl. G06T 7/00; G06F 3/14; G06F 3/04847

(52) U.S. Cl. CPC G06T 7/0002; G06F 3/14; G06F 3/04847; G06T 7/97; G06T 2200/24; G06T 2207/30184

(57) ABSTRACT

An information processing apparatus obtains pieces of defect data respectively extracted from a plurality of images captured at different times and detects developing defects on the basis of differences between the pieces of defect data extracted from the images captured at the different times. The information processing apparatus further calculates priority levels of the defects on the basis of the differences between the pieces of defect data, specifies regions that cover the developing defects, and displays the specified regions in accordance with the priority levels.

### BACKGROUND

### Field of the Disclosure

The present disclosure relates to an information processing technique for detecting defects in structures and the like on the basis of captured images.

### Description of the Related Art

In inspection of an infrastructure, such as a bridge or a tunnel, by using images, a technique is employed in which a plurality of high-resolution images are captured and composited to generate one composite image in order to detect defects, such as cracks and exposed reinforcing rods, appearing on wall surfaces of the structure. Further, to determine the soundness of members of a structure, it is desirable to detect defects from images of wall surfaces of the structure captured at different times and grasp how far the defects have developed (that is, aging). In this case, the degree of development of each defect is calculated by, for example, obtaining the difference between detected defects.

Japanese Patent Laid-Open No. 2019-20220 discloses a technique in which images captured at different times are input, the position shift between defects is corrected, and thereafter, a developing defect is calculated.

Although a developing defect can be calculated by using the technique disclosed in Japanese Patent Laid-Open No. 2019-20220, for an image obtained by compositing a plurality of high-resolution images as described above, a large number of regions that include developing defects may be calculated. In this case, the operator who performs the inspection is to check the large number of regions that exhibit development and may overlook a defect region that is to be checked.

### SUMMARY

Accordingly, some embodiments provide a technique for reducing the possibility of the operator overlooking a defect that is to be checked.

Some embodiments of the present disclosure provide an information processing apparatus including: an obtaining unit configured to obtain pieces of defect data respectively extracted from a plurality of images captured at different times; a detection unit configured to detect developing defects on the basis of differences between the pieces of defect data extracted from the images captured at the different times; a calculation unit configured to calculate priority levels of the defects on the basis of the differences between the pieces of defect data; a specifying unit configured to specify regions that cover the developing defects; and a display unit configured to display the specified regions in accordance with the priority levels.

Further features of various embodiments will become apparent from the following description of exemplary embodiments with reference to the attached drawings.

### BRIEF DESCRIPTION OF THE DRAWINGS

FIG. 1 is a diagram illustrating an example hardware configuration of an information processing apparatus.

FIGS. 2A and 2B are diagrams illustrating an example relationship between a drawing and an examination target image.

FIGS. 3A and 3B are diagrams illustrating example lists of detected defects.

FIG. 4 is a flowchart of information processing according to a first embodiment.

FIGS. 5A and 5B are diagrams illustrating an example list of developing defects.

FIG. 6 is a flowchart of a priority level calculation process.

FIG. 7 is a flowchart of a region specifying process.

FIGS. 8A to 8I are diagrams illustrating examples of specification of a region.

FIG. 9A is a diagram illustrating an example of a region specification table and FIG. 9B is a diagram illustrating an example of a check screen.

10A and 10B are diagrams illustrating example user interface (UI) screens related to priority level changes.

FIGS. 11A to 11C are diagrams illustrating example UI screens related to region selection.

FIGS. 12A and 12B are diagrams illustrating an example of priority level calculation based on the degree of development (development rate).

FIG. 13 is a diagram illustrating an example system configuration according to a second embodiment.

FIG. 14 is a flowchart of information processing by a server according to the second embodiment.

FIG. 15 is a flowchart of information processing by a client terminal according to the second embodiment.

### DESCRIPTION OF THE EMBODIMENTS

Hereinafter, some example embodiments will be described with reference to the drawings.

The following embodiments are not intended to limit every embodiment, and all combinations of features described in the embodiments might not be essential to every embodiment. Configurations according to the embodiments can be corrected or changed as appropriate on the basis of the specifications of an apparatus to which the present disclosure is applied and various conditions (the use conditions, use environment, and the like). Portions of embodiments described below may be combined as appropriate. In the following embodiments, the same configurations are assigned the same reference numerals to give descriptions thereof.

### First Embodiment

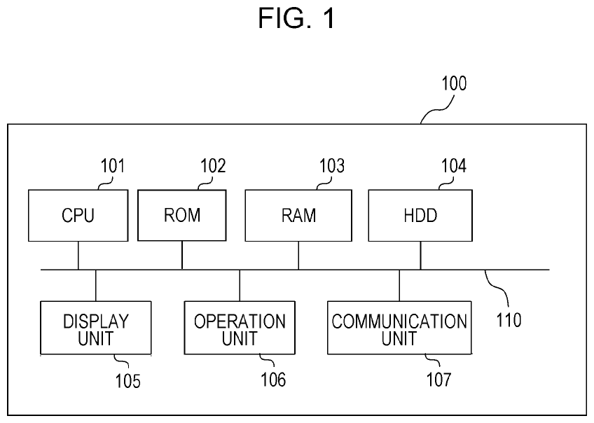

FIG. 1 is a block diagram illustrating an example overall configuration of an information processing apparatus 100 according to this embodiment.

The information processing apparatus 100 includes a central processing unit (CPU) 101, a read-only memory (ROM) 102, a random access memory (RAM) 103, a hard disk drive (HDD) 104, a display unit 105, an operation unit 106, and a communication unit 107.

The CPU 101 performs calculation, logical determination, and the like for various processes and controls constituent elements connected to a system bus 110. The ROM 102 is a program memory and stores a program that includes a control procedure and an information processing procedure and that is executed by the CPU 101. The program stored in the ROM 102 includes a program of various information processing procedures according to this embodiment described below. The RAM 103 is used as a temporary memory area that serves as the main memory, a work area, and the like of the CPU 101. Note that the program memory may be implemented as a process of loading the program to the RAM 103 from an external storage device or the like connected to the information processing apparatus 100.

The HDD 104 is a device that includes a hard disk for storing electronic data, such as image data, and a program according to this embodiment. As a device that plays a role similar to that of the HDD 104, an external storage device may be used. The external storage device can be implemented as, for example, a medium (recording medium) and an external storage drive that enables access to the medium. Examples of the medium include a flexible disk (FD), a compact disc read-only memory (CD-ROM), a digital versatile disc (DVD), a universal serial bus (USB) memory, a magneto-optical (MO) disk, and a flash memory. The external storage device may be, for example, a server connected via a network.

The display unit 105 includes, for example, a liquid crystal display (LCD) or an organic electroluminescence display (OELD), and generates and displays on the screen of any of these displays, an image or a graphical user interface (GUI). Note that the display unit 105 may be included in an external device that is connected to the information processing apparatus 100 by wire or wirelessly.

The operation unit 106 includes a keyboard and a mouse and accepts various operations performed by a user, such as an operator performing defect investigation and inspection described below.

The communication unit 107 performs wired or wireless bidirectional communication with another information processing apparatus, a communication device, an external storage device, and the like on the basis of a publicly known communication technique.

The information processing apparatus 100 according to this embodiment detects defects, such as cracks and exposed reinforcing rods, appearing on an infrastructure, such as a bridge or a tunnel, from captured high-resolution images of the infrastructure and determines aging that indicates how far the defects have developed. The information processing apparatus 100 according to this embodiment further calculates priority levels on the basis of the degrees of importance of the developing defects and changes the display method for the regions of the developing defects on the basis of the priority levels. Specifically, the information processing apparatus 100 according to this embodiment obtains pieces of defect data respectively extracted from a plurality of images captured at different times, calculates differences between the pieces of defect data respectively extracted from the images captured at the different times, and detects developing defects on the basis of the differences. The information processing apparatus 100 according to this embodiment calculates the priority levels of the defects on the basis of the differences between the pieces of defect data, specifies regions that cover the developing defects, and displays the specified regions in accordance with the priority levels.

Before a detailed description of the information processing apparatus 100 according to this embodiment is given, a relationship between an image and defect data indicating defects, and structural information regarding an infrastructure or the like will be described. In inspection using images, it is desirable to manage captured images of wall surfaces and the like of a structure in association with a drawing of the structure.

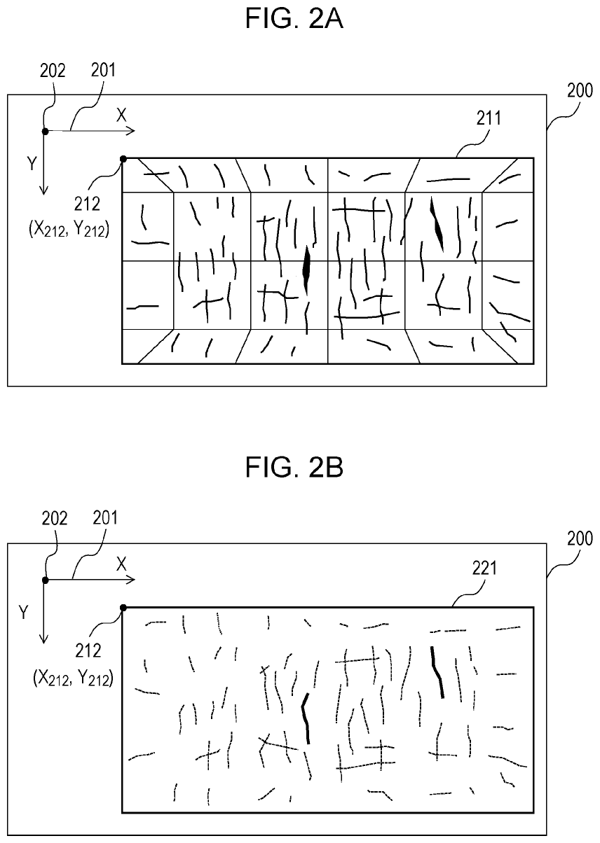

FIG. 2A is a diagram illustrating a state where an image 211 that is a captured image of a wall surface of a bridge, which is an example infrastructure, is superimposed on an image of a drawing 200. The image of the drawing 200 has a drawing coordinate system 201 having a point 202 as the origin. The position of the image on the drawing is defined by the coordinates of the vertex at the top left of the image. For example, the position of the image 211 is defined by the coordinates (X₂₁₂, Y₂₁₂) of a vertex 212. The image data of the drawing 200 and data of the image 211 are stored in the RAM 103 and the HDD 104, which are storage units, together with coordinate information of the drawing 200 and that of the image 211.

In this embodiment, an image used in an image inspection of an infrastructure is captured at a high resolution such that, for example, one pixel corresponds to 1 mm on the structure so as to enable checking of a very small crack and the like, and therefore, has a large size. For example, it is assumed that the image 211 in FIG. 2A is a captured image of a slab of a bridge with dimensions of 20 m×10 m. In a case where the image resolution is 1.0 mm per pixel (1.0 mm/pixel), the image size of the image 211 is equal to 20,000 pixels×10,000 pixels. In a case where, for example, a large number of defects including cracks and exposed reinforcing rods are present in 1000 locations or more in the image 211 captured at a high resolution, it is difficult to show all of the defects on the figure, and therefore, some of the defects are shown in FIGS. 2A and 2B. In figures that are referred to in the following description and that show an image or defect data of a wide area, defects shown on the figures are limited to some defects.

Defect data is information about the result of automatic detection of defects detected (extracted) from a captured image by performing an image analysis process for defects, such as cracks, appearing on a concrete wall surface, or information that is a record obtained as a result of input by a person who determines defects from a captured image. The information processing apparatus 100 according to this embodiment obtains defect data thus extracted from a captured image. The description of this embodiment is given under the assumption that an input image and defect data are managed in association with drawing coordinates.

FIG. 2B illustrates a state where defect data 221 corresponding to the image 211 is superimposed on the image of the drawing 200 at a position the same as the position of the image 211 in FIG. 2A. The defect data 221 includes a large number of defects (for example, 1000 or more defects) including defects not shown on the figure. The position, on the drawing, of each defect in the defect data 221 is defined by the coordinates of each pixel that forms the defect.

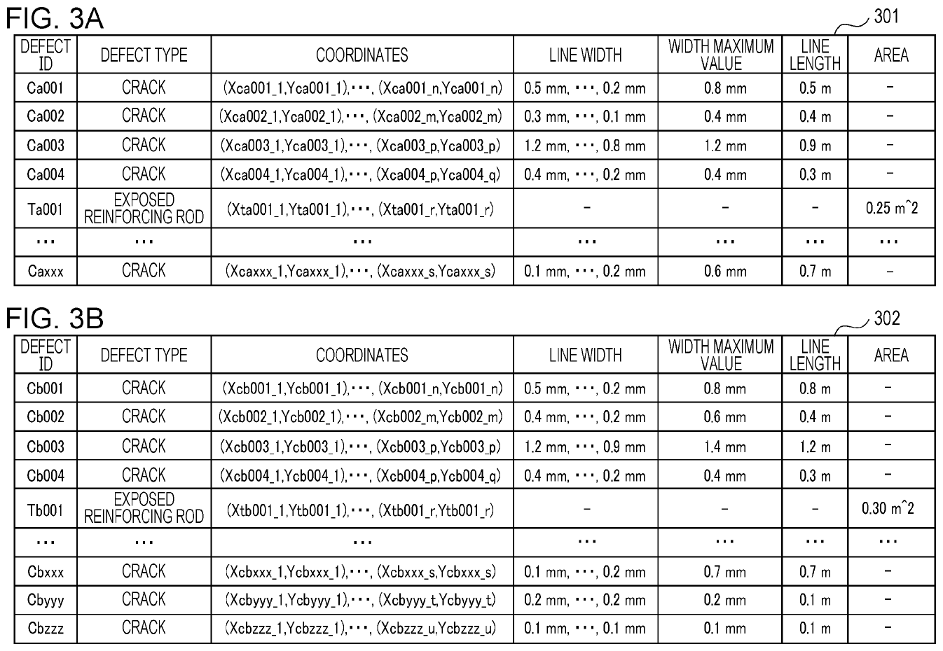

FIG. 3A is a diagram illustrating an example of a defect data table 301 that shows the data structure of defect data. A description of a defect data table 302 illustrated in FIG. 3B will be described below.

The defect data table 301 includes items, namely, a defect ID, a defect type, coordinates, a line width, a width maximum value, a line length, and an area. The defect ID indicates identification information (ID) of a detected defect, and the defect type indicates the type of defect, such as “crack” or “exposed reinforcing rod”. The coordinates include a plurality of pieces of coordinate information of pixels that form a defect. The line width includes attribute values each indicating the width of a defect at a position indicated by the corresponding coordinates in a case where the defect type is “crack”. The width maximum value indicates the maximum numerical value of the line width in a case where the defect type is “crack”, and the line length indicates the total length of a crack. The area indicates, in a case where the defect type is, for example, “exposed reinforcing rod”, which is a defect having a region, the area of the region. For example, regarding a defect ID Ca001, the defect type is “crack”, and the coordinates include (Xca001_1, Yca001_1) to (Xca001_n, Yca001_n), which are sets of coordinates of n contiguous pixels.

As described above, this embodiment assumes that defect data is expressed by pixels. Defect data may be expressed by vector data of, for example, a polyline or a curve formed of a plurality of points. In a case where defect data is expressed by vector data, the data amount is reduced and the expression becomes more simplified. A defect ID Ta001 is an example of a defect, other than a crack, having a region shape, and the defect type is “exposed reinforcing rod”. In a case where, for example, an exposed reinforcing rod having a region shape is expressed by coordinate information, the defect has a region outlined by a polyline. Note that information included in defect data is not limited to the information included in the defect data table 301, and information about the other attributes may be retained.

The information about the other attributes may include structural information concerning the structure of the examination target. The structural information is information including the type and basic structure of the structure, various dimensions of the structure, member information, the year of completion, and other specifications. The information about the other attributes may include information about repair records concerning maintenance, including the years of repairs, repaired portions, and repair methods. This embodiment assumes that structural information regarding specific positions in the structure, such as member information and repair information, is stored together with information about the positions on the drawing. That is, the position of each member on the drawing and the positions of repaired portions on the drawing are stored as part of the structural information. Therefore, a correspondence between the structural information and the image and defect data can be obtained with reference to the drawing. The structural information is stored in the RAM 103 and the HDD 104, which are storage units, together with the image and defect data and can be obtained from the RAM 103 or the HDD 104. Note that information included in the structural information is not limited to the above-described information, and other information may be further retained. In accordance with the type of structure, information specific to the type may be retained.

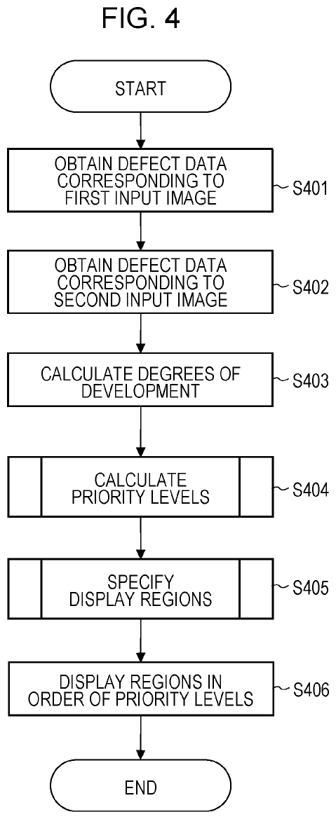

FIG. 4 is a main flowchart illustrating a flow of an aging priority display process, which is information processing performed by the information processing apparatus 100 according to this embodiment. The information processing apparatus 100 according to this embodiment uses two images (a first input image and a second input image) captured at different times and calculates the degrees of development of defects appearing on a wall surface of a structure. It is assumed that the time when the second input image was captured is the time after the elapse of several years (for example, five years) since the time when the first input image was captured. In the following description, each step in FIG. 4 is described with the prefix “S” added to its reference numeral.

In S401, the CPU 101 obtains defect data (first defect data) corresponding to the first input image from among pieces of defect data stored in a storage unit. It is assumed that the first defect data is data obtained from the defect data table 301 illustrated in FIG. 3A. As the defect data, for example, crack data is described here. It is assumed that the crack data is, for example, information input by manually tracing cracks on the image or information obtained by automatic detection using a model trained in advance through machine learning, and is data stored in a storage unit.

In S402, the CPU 101 obtains defect data (second defect data) corresponding to the second input image as in S401. It is assumed that the defect data corresponding to the second input image is included in, for example, the defect data table 302 illustrated in FIG. 3B. The defect data table 302 illustrated in FIG. 3B is a table similar to the defect data table 301 described above and illustrated in FIG. 3A. Similar to the defect data table 301, it is assumed that the defect data table 302 illustrated in FIG. 3B includes information input by manual tracing on the second input image or information obtained by automatic detection using a model trained through machine learning, and is data stored in advance in a storage unit. That is, the CPU 101 obtains the second defect data corresponding to the second input image from the defect data table 302 stored in a storage unit.

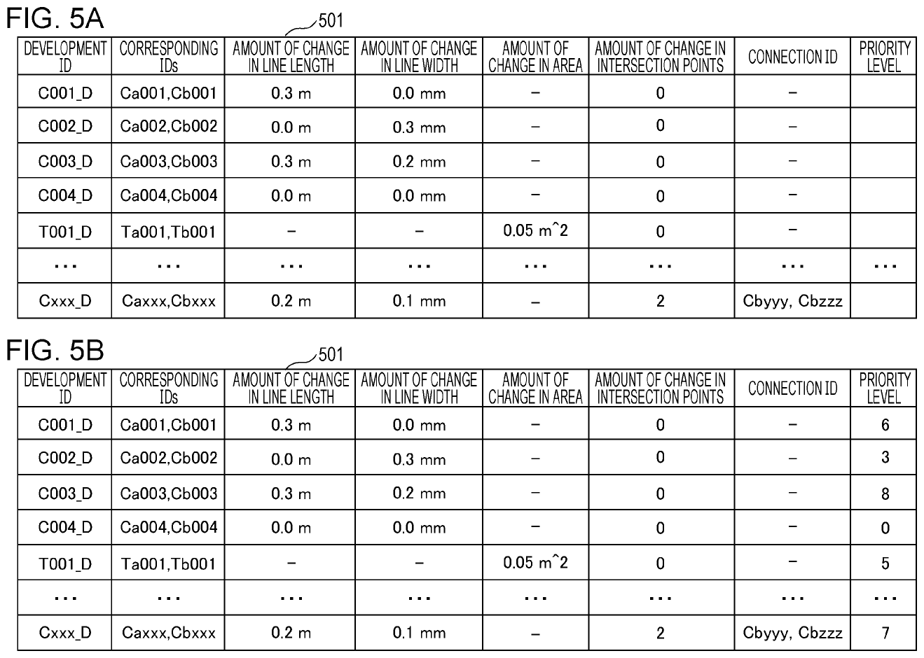

Next, in S403, the CPU 101 calculates difference values from the first defect data and the second defect data and creates an aging data table 501 illustrated in FIGS. 5A and 5B as information indicating the degrees of development of defects.

FIG. 5A illustrates the aging data table 501 obtained by calculating difference values from the first defect data and the second defect data. The aging data table 501 illustrated in FIG. 5B will be described below.

The aging data table 501 includes items, namely, a development ID, corresponding IDs, the amount of change in line length, the amount of change in line width, the amount of change in area, the amount of change in intersection points, a connection ID, and a priority level. The development ID indicates the ID of a developing defect. The corresponding IDs are the defect IDs of defects that are compared with each other and include a defect ID in the first defect data and a defect ID in the second defect data. The first defect data and the second defect data may be associated with each other by using an existing technique. For example, from the outlines of defects extracted from the first input image and from the outlines of defects extracted from the second input image, centers of gravity and feature values may be calculated, and the distance between calculated feature values and the distance between other calculated feature values may be compared with each other to thereby perform alignment. The amount of change in line length, the amount of change in line width, the amount of change in area, and the amount of change in intersection points are each indicated as a difference value between the first defect data and the second defect data. Specifically, the amount of change in line length is calculated as the difference between a line length for a defect ID in the first defect data and a line length for a defect ID in the second defect data, the defect IDs being included in the corresponding IDs. Similarly, the amount of change in line width is calculated as the difference in the line width maximum value between the first defect data and the second defect data, and the amount of change in area is calculated as the difference in the area between the first defect data and the second defect data. The amount of change in intersection points is calculated from the difference between the number of intersection points in a defect in the first defect data and the number of intersection points in a corresponding defect in the second defect data. The connection ID includes the defect ID of a defect in the second defect data newly detected for a corresponding defect in the first defect data.

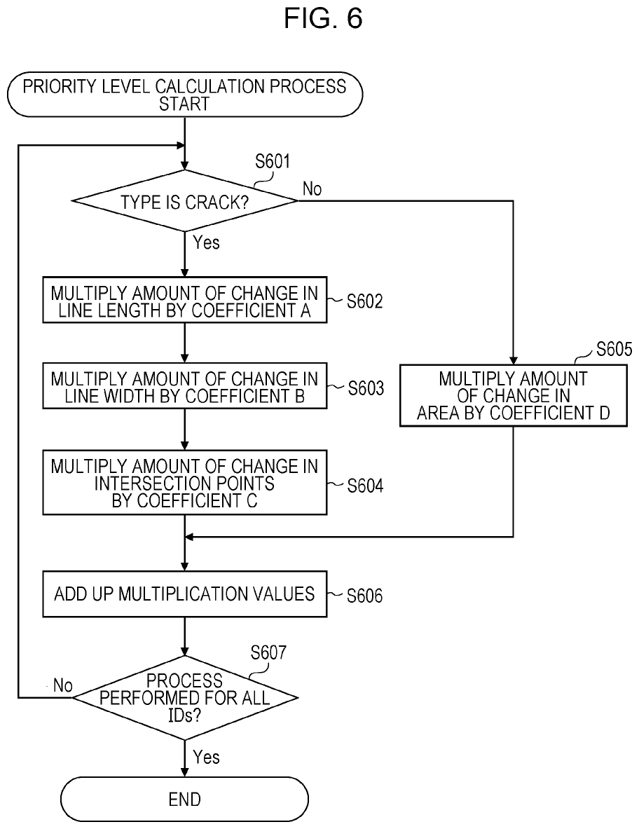

Next in S404, the CPU 101 performs a process for calculating priority levels that are to be checked by the operator, on the basis of the degrees of importance of developing defects, and includes the priority levels in the item of priority level of the aging data table. This process will be described in detail below with reference to the flowchart in FIG. 6.

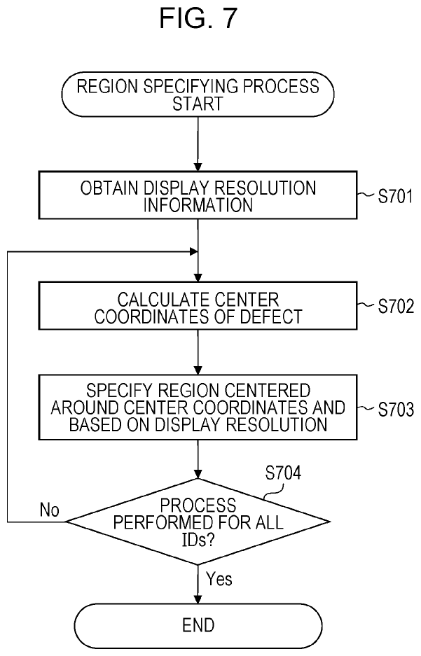

Next, in S405, the CPU 101 specifies regions (regions of interest) that are displayed as portions to which the operator is to pay attention to check development of defects. This process will be described in detail below with reference to the flowchart in FIG. 7.

Next, in S406, the CPU 101 displays the regions of interest specified in S405 on the display unit 105 one by one, in order of the priority levels calculated in S404 for defects included in the regions. After the operator has checked the region displayed on the display unit 105, the operator, for example, clicks the mouse or presses a specific key of the keyboard included in the operation unit 106. Accordingly, the CPU 101 recognizes that checking by the operator is completed. The CPU 101 displays on the display unit 105 a region having a priority level subsequent to a priority level corresponding to the currently displayed region.

FIG. 6 is a flowchart illustrating a detailed flow of the priority level calculation process in S404 in FIG. 4.

In S601, the CPU 101 performs a process for development IDs included in the aging data table 501 sequentially and determines the type of defect for a processing target development ID. In the priority level calculation process, a priority level calculation reference differs depending on the type of defect, and therefore, the CPU 101 first determines the type of defect for the processing target development ID in S601. Here, it is assumed that the CPU 101 determines whether the type of defect for the processing target development ID is “crack”. If the type of defect is “crack” (Yes), the CPU 101 proceeds to the process in S602. If the type of defect is not “crack” (No), the CPU 101 proceeds to the process in S605.

When the process proceeds to S602, the CPU 101 multiples the value of the amount of change in line length for the target development ID in the aging data table 501 by a coefficient A. In this embodiment, the coefficient A is set to 20. In a case of the aging data table 501, the CPU 101 multiples 0.3, which is the amount of change in line length for a development ID C001_D, to thereby obtain 6 as the multiplication value.

Next, in S603, the CPU 101 multiples the value of the amount of change in line width for the target development ID in the aging data table 501 by a coefficient B. In this embodiment, the coefficient B is set to 10. In the case of the aging data table 501, the CPU 101 multiplies 0.0, which is the amount of change in line width for the development ID C001_D, to thereby obtain 0 as the multiplication value.

Next, in S604, the CPU 101 multiples the value of the amount of change in intersection points for the target development ID in the aging data table 501 by a coefficient C. In this embodiment, the coefficient C is set to 1. In the case of the aging data table 501, the CPU 101 multiplies 0, which is the amount of change in intersection points for the development ID C001_D, to thereby obtain 0 as the multiplication value. After S604, the CPU 101 proceeds to the process in S606.

In a case where the process proceeds to S605, the CPU 101 multiples the value of the amount of change in area for the target development ID in the aging data table 501 by a coefficient D. In this embodiment, the coefficient D is set to 100. In the case of the aging data table 501, the CPU 101 multiplies 0.05, which is the amount of change in area for a development ID T001_D, to thereby obtain 5 as the multiplication value. After S605, the CPU 101 proceeds to the process in S606.

The values of the coefficients A to D are set so as to weight the priority level such that the amount of change in line length>the amount of change in line width>the amount of change in area>the amount of change in intersection points holds. For example, the coefficient A is set to 20, the coefficient B is set to 10, the coefficient C is set to 1, and the coefficient D is set to 100. These coefficients may be changed on the basis of values in the aging data table 501. For example, the coefficient values may be set on the basis of normalization based on a unit of, for example, m (meter) or mm (millimeter).

Next, in S606, the CPU 101 adds up the multiplication values obtained in S602 to S604 or the multiplication value obtained in S605 and includes the resulting value in the item of priority level in the aging data table 501 as illustrated in FIG. 5B.

Subsequently, in S607, the CPU 101 determines whether the process has been performed for all development IDs. If the process has been performed for all development IDs (Yes), the CPU 101 ends the process in the flowchart in FIG. 6. If a development ID for which the process is not yet performed is present (No), the development ID for which the process is not yet processed is assumed to be the processing target ID, and the process returns to S601.

FIG. 7 is a flowchart illustrating a detailed flow of the region-of-interest specifying process in S405 in FIG. 4.

In S701, the CPU 101 obtains information about the display resolution of the display of the display unit 105 in the information processing apparatus 100. Here, it is assumed, for example, that the display is a liquid crystal display and the display resolution is that of full High Definition (HD). It is assumed that the display resolution of full HD is 1920×1080.

In S702, the CPU 101 obtains coordinate information of defect data for a processing target defect ID from the defect data table 302 illustrated in FIG. 3B and calculates the coordinates of the center. As the calculation method, a method can be used in which, for example, the average of the maximum value and the minimum value of the X coordinate in the horizontal direction and the average of the maximum value and the minimum value of the Y coordinate in the vertical direction among the coordinates in the defect data table are assumed to be the center coordinates (Xm, Ym).

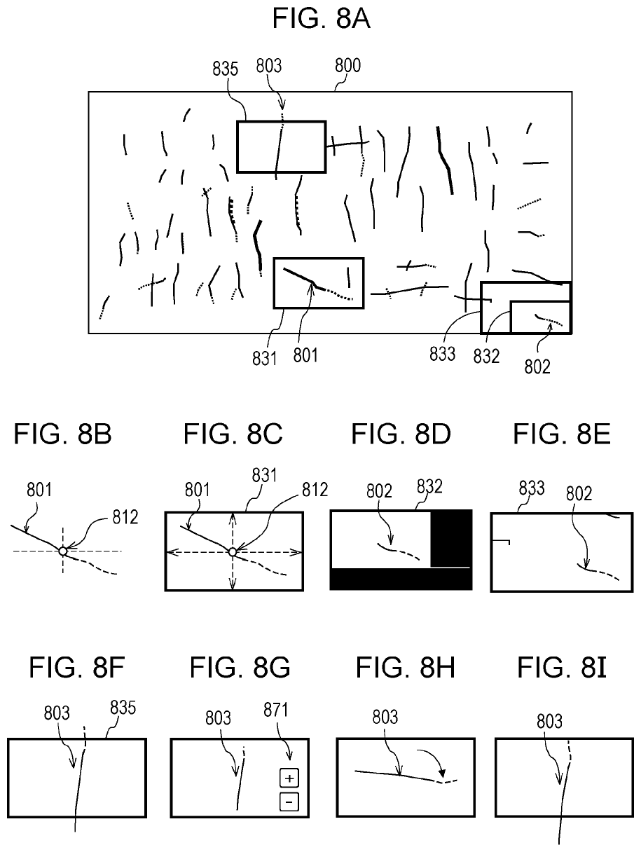

Regarding the process in S702, a supplementary explanation will be given with reference to FIG. 8A to FIG. 8I.

FIG. 8A is a diagram illustrating, for example, a developing defect superimposed image 800 and a crack 801.

The developing defect superimposed image 800 is an example image obtained by superimposing and displaying cracks detected as defects on the second input image. In the example in the figure, the crack 801 is formed of a solid-line portion and a dotted-line portion. The solid-line portion depicts a crack obtained from the first defect data, and the dotted-line portion depicts a crack obtained from the second defect data, that is, a portion that has developed due to aging. Although the existing portion is depicted by a solid line and the developing portion is depicted by a dotted line for convenience of explanation, another method may be employed in which the developing portion is highlighted and displayed by, for example, changing the color of the developing portion or making the line thicker.

FIG. 8B is a diagram illustrating a center 812 of the crack 801, and the coordinates of the center 812 are (Xm, Ym). Although the average values are calculated as the coordinates of the center 812 in this example, a method in which the value of center of gravity is calculated may be used or another method may be used.

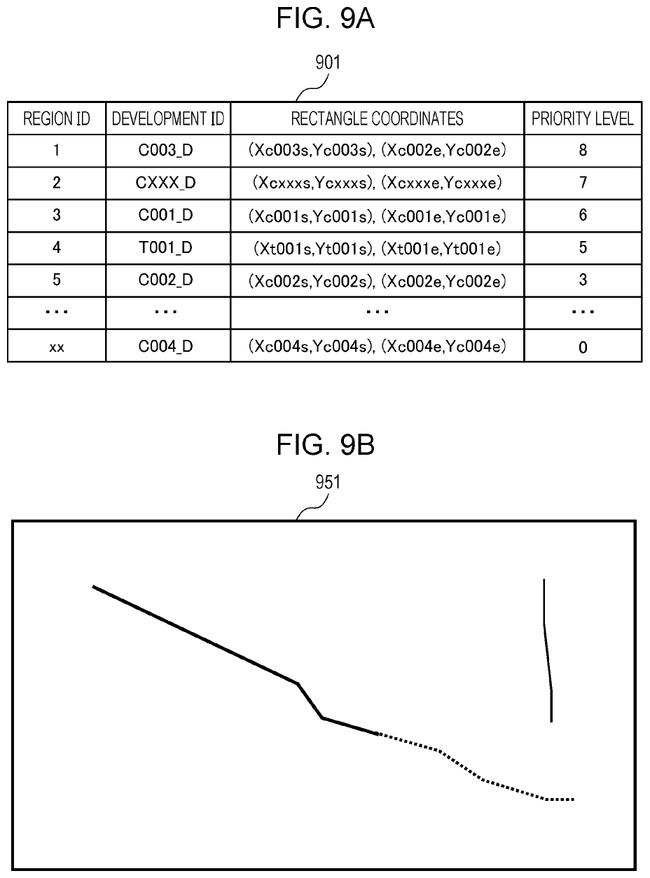

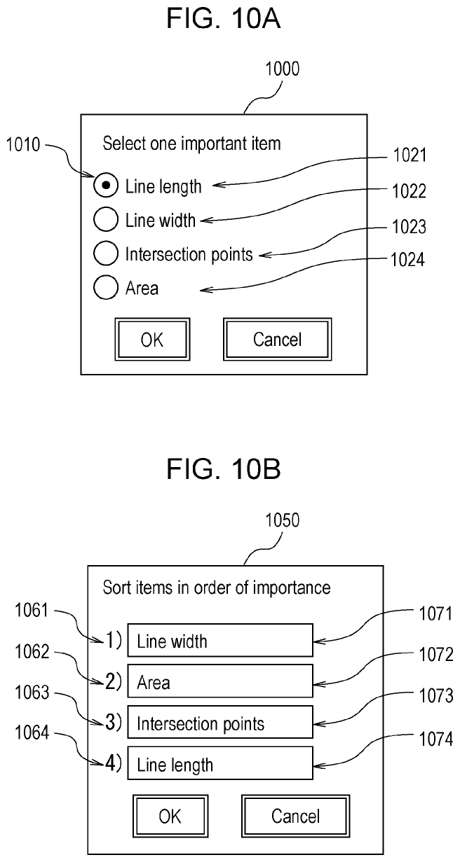

Next, in S703, the CPU 101 sets a rectangular region that covers the defect on the basis of the coordinates of the center 812 (center coordinates) calculated in S702 and the display resolution obtained in S701 and saves information about the rectangular region in a region table, an example of which is illustrated in FIG. 9A described below. For example, it is assumed that the display resolution obtained in S701 is 1920×1080 and the center coordinates obtained in S702 are (Xm, Ym). Then, the rectangular region is expressed as a region for which the top left coordinates are (Xm−960, Ym−540) and the bottom right coordinates are (Xm+960, Ym+540).

FIG. 9A is a diagram illustrating an example of a region table 901.

The region table 901 includes items, namely, a region ID, a development ID, rectangle coordinates, and a priority level. The development ID and the priority level are the development ID and the priority level in the aging data table illustrated in FIG. 5A or 5B, and region IDs are assigned in order of priority level. The rectangle coordinates include the top left coordinates and the bottom right coordinates of the rectangular region described above.

FIG. 8C is a diagram illustrating an example where a rectangular region outlined by an outer frame 831 and centered around the center 812 of the crack 801 is calculated.

FIG. 9B is a diagram illustrating an example of a check screen 951 that is displayed on the display unit 105. The check screen 951 is a screen obtained by cutting the rectangular region from the developing defect superimposed image 800.

There may be a crack, such as a crack 802 in FIG. 8A, for which the center is close to an edge portion (the top side, the bottom side, the left-hand side, or the right-hand side) of the developing defect superimposed image 800 and it is not possible to set a rectangular region based on the display resolution. In this case, a rectangular region outlined by an outer frame 832 in which the region outside the image is blacked out as illustrated in FIG. 8D may be generated. Another method may be employed in which a rectangular region outlined by an outer frame 833 is set such that the portion outside the edge portion is not selected and the center of the defect does not correspond to the center of the rectangular region as illustrated in FIG. 8E.

In this embodiment, although an example is described where a region is displayed at the same magnification on the display screen, the magnification is not limited to the same magnification as long as the operator can check a developing defect, and the operator may be allowed to set the magnification. For example, as in the example illustrated in FIG. 8F, in a case where a crack 803 including a developing portion does not fit in the rectangular region outlined by an outer frame 835, the display magnification may be changed such that the entire defect fits in the rectangular region as in the example illustrated in FIG. 8G. In this case, a UI, such as a zoom button 871, may be used to allow the operator to change the display magnification with which the defect can be checked. As in the example illustrated in FIG. 8H, display may be changed in such a manner that the crack 803 is rotated by a desired angle, such as 90 degrees, to thereby display the crack 803 entirely within the rectangular region at the same magnification. As in the example illustrated in FIG. 8I, the position of display may be changed in the vertical direction such that the developing portion of the crack 803 is displayed within the rectangular region at the same magnification.

Next, in S704, the CPU 101 determines whether the process has been performed for all processing target IDs. If the process has been performed for all IDs (Yes), the CPU 101 ends the process in the flowchart in FIG. 7. If another ID for which the process is to be performed is present (No), the process returns to S702, and the CPU 101 changes the processing target to the next ID.

As described above, in this embodiment, the information processing apparatus 100 calculates the degrees of development of defects detected from two images captured at different times, specifies regions that cover the defects on the basis of the display resolution, and displays the regions of the defects in accordance with the degrees of development. Accordingly, the information processing apparatus 100 according to this embodiment can display a defect that has a high degree of development and that is to be preferentially checked among a large number of defects in accordance with the degree of development, at a resolution with which the operator can check the defect.

In this embodiment, although the process for obtaining defect data of the first input image in S401 is an example process of using data of defects detected in the past, for example, defect data may be detected again on the basis of a newly set current reference. For example, there may be a case where the performance of a processing algorithm for detecting defects becomes higher than that at the time when the first defect data, which is past processing data, was generated and it becomes possible to detect a larger number of defects than in the first defect data in the past. In such a case, when the new processing algorithm is used to detect defect data, defects that were unable to be detected at the time when the first input image was captured can be compared with the current second defects, and developing defects can be grasped more accurately. In the process for obtaining defect data of the second input image in S402, defect data detected in advance may be used as input data.

In this embodiment, the first input image and the second input image are images that have been aligned with each other on the drawing, and a process for alignment between the images is not necessary. Therefore, when differences are simply calculated, aging data can be generated. On the other hand, for example, in a case where the first input image and the second input image are not aligned with each other, the process for alignment between the images may be performed, the differences between the images may be calculated, and aging data may be generated. In the process for alignment in this example case, an existing technique may be used. For example, the information processing apparatus may calculate feature points from each of the images and perform alignment on the basis of corresponding feature points. For example, the operator may manually specify corresponding points in the images and perform alignment.

In this embodiment, although the degrees of development are calculated on the basis of the differences between the first defect data and the second defect data, the information processing apparatus may calculate the degrees of development by further using third defect data captured at a different time and calculating the differences. When the differences between three or more pieces of defect data are used, the degrees of development that indicate accelerations can be calculated. The values of coefficients by which the values of degrees of development indicating accelerations are respectively multiplied may be changed. For example, in a case where a degree of development is high, the value of a corresponding coefficient in the flowchart in FIG. 6 is increased (made larger) to thereby increase the priority level. Accordingly, the operator can preferentially check the defect.

In this embodiment, although an example where the priority level is calculated on the basis of the degree of development of a defect has been described, for example, the priority level may be calculated by further using information indicating attributes of the structure. For example, regarding the slab of a bridge, an item on which the operator responsible for investigation and inspection places importance differs between the region of a portion near a bridge pier and the region of a middle portion between bridge piers even if the degrees of development of cracks are the same. Therefore, the information processing apparatus changes the values of coefficients used in calculation of the priority level by using, for example, information about the region of the portion near a bridge pier and information about the region of the middle portion between bridge piers as information indicating attributes of the structure. Similarly, an item on which the operator places importance differs between an upper portion and a lower portion of a bridge pier, and therefore, the information processing apparatus may change the values of coefficients to be used in priority level calculation, by using information about the upper portion and the lower portion as attribute information of the structure.

In this embodiment, an example where defects develop over time has been described. In a case where a defect has been repaired during the period from capturing of the first input image to capturing of the second input image, the line of a crack detected as a difference may become shorter or the area may be reduced. In this case, although the amount of difference has a negative value, the amount of difference may be assumed to be zero because the defect has not developed, and the defect may be excluded from display targets.

In the description of this embodiment, although processes that are performed by the CPU 101 of the information processing apparatus 100 have been described as steps in the flowchart in FIG. 4, the processes in the respective steps can be represented by a functional block diagram including functions that are implemented by the CPU 101. The functions of functional blocks may be substantially the same as the steps in FIG. 4, and therefore, illustrations and descriptions thereof are omitted.

### First Modification of First Embodiment

In the priority level calculation process according to the first embodiment, the priority level is calculated by multiplication by predetermined coefficients. In a first modification of the first embodiment, an example will be described where the operator responsible for inspection and investigation is allowed to change via a UI the priority level calculation reference (calculation rule) to thereby make the order in which the regions are presented to the operator changeable.

FIG. 10A is a diagram illustrating an example of a UI screen 1000 that is presented to the operator responsible for investigation and inspection, who is a user. The UI screen 1000 allows the operator to select an item on which the operator places importance when the priority level is calculated, and includes radio buttons 1010 and important items 1021 to 1024. Each of the radio buttons 1010 is a button that is selected when the operator selects a corresponding one of the important items 1021 to 1024. The important items 1021 to 1024 that can be selected by using the radio buttons 1010 respectively correspond to the coefficients A to D described with reference to the flowchart in FIG. 6. In the first modification of the first embodiment, the value of a coefficient corresponding to an important item selected by using the radio button 1010 is relatively made higher, and the values of coefficients corresponding to items not selected are relatively made lower.

The UI screen on which the priority level calculation reference (priority level calculation rule) can be changed in the first modification of the first embodiment has been described above. Accordingly, the operator can change the priority level calculation rules and can change an item on which the operator wants to place importance.

### Second Modification of First Embodiment

In the first modification of the first embodiment, an example of the UI screen 1000 including radio buttons has been described. In a second modification of the first embodiment, an example UI via which the priority ranks of important items are changed will be described.

FIG. 10B is a diagram illustrating an example of a UI screen 1050 according to the second modification of the first embodiment. The UI screen 1050 includes priority ranks 1061 to 1064 and important items 1071 to 1074. On the UI screen 1050, for the priority ranks 1061 to 1064, the important items 1071 to 1074 are selected, and the items can be replaced or changed accordingly. On the basis of the changed priority ranks, the intensities of the values of coefficients for the important items or the magnitudes of the values are changed. In the example illustrated in FIG. 10B, the coefficient B for the line width is assigned the first priority rank, the coefficient D for the area is assigned the second priority rank, the coefficient C for the intersection points is assigned the third priority rank, and the coefficient A for the line length is assigned the fourth priority rank. In this case, the information processing apparatus sets the magnitudes of the values set for the respective coefficients such that coefficient B>coefficient D>coefficient C>coefficient A holds.

Accordingly, the priority level can be changed in accordance with the operator's intention.

### Third Modification of First Embodiment

In the first and second modifications of the first embodiment, the operator checks (visually checks) the screen showing developing defects from region to region. In a third modification of the first embodiment, an example will be described where a developing defect is displayed at a display resolution with which the operator can visually check (can check) the defect and the overall image is also displayed.

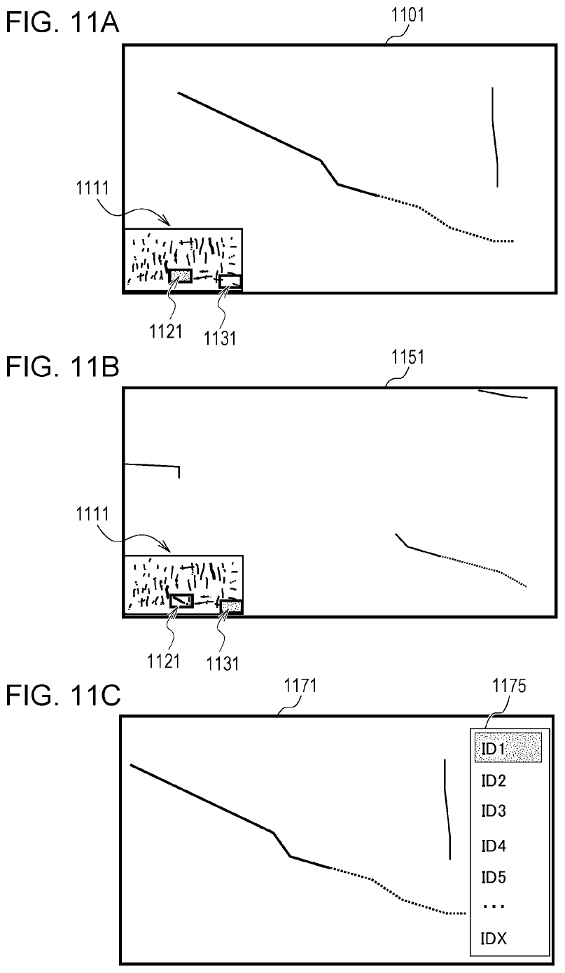

FIG. 11A illustrates an example of a check screen 1101. On the check screen 1101, a region the same as that displayed on the check screen 951 illustrated in FIG. 9B is displayed and a reduced image 1111 is further displayed in FIG. 11A. In the reduced image 1111, a rectangular region 1121 displayed on the check screen 1101 and a rectangular region 1131 displayed on a check screen 1151 illustrated in FIG. 11B described below are displayed. The rectangular region 1121 corresponds to the region outlined by the outer frame 831 illustrated in FIG. 8A of the first embodiment, and the rectangular region 1131 corresponds to the region outlined by the outer frame 833 illustrated in FIG. 8A of the first embodiment. In FIG. 11A, the rectangular region 1121 is highlighted and displayed. Similarly, on the check screen 1151 illustrated in FIG. 11B, when the rectangular region 1131 is displayed on the display unit 105, the rectangular region 1131 is highlighted and displayed.

In the description of FIG. 11A and FIG. 11B, although an example where two rectangular regions are displayed in the reduced image 1111 has been described, a plurality of rectangular regions, namely, three or more rectangular regions, including developing defects may be displayed. When the operator responsible for investigation and inspection performs a selection operation of, for example, clicking a region to be checked next on the reduced image 1111, the selected region may be specified. The information processing apparatus may change the method for presenting regions to be checked by the operator, by changing the color, the color intensity, or the color saturation of the outer frame of each of the rectangular regions in order of priority level.

As described above, according to the third modification of the first embodiment, a region to be checked can be selected as desired in accordance with the operator's intention and, for example, the operator can check a region having a high priority level and can simultaneously check the region of a defect having a low priority level around the region having a high priority level.

Instead of displaying a reduced image, a method may be employed in which display in a list form in which items are arranged in order of priority level as illustrated as a list 1175 on the check screen 1171 in FIG. 11C is performed to allow an item to be selected.

### Fourth Modification of First Embodiment

In the first, second, and third modifications of the first embodiment, the coefficient is changed in accordance with whether the amount of development in a defect is the amount of increase in the line length or the amount of increase in the line width of a crack, or the amount of increase in the area of an exposed reinforcing rod, as illustrated in the flowchart in FIG. 6 to thereby calculate the priority level. In a fourth modification of the first embodiment, an example where the priority level is calculated on the basis of the rate at which a defect develops (degree of development or development rate) will be described.

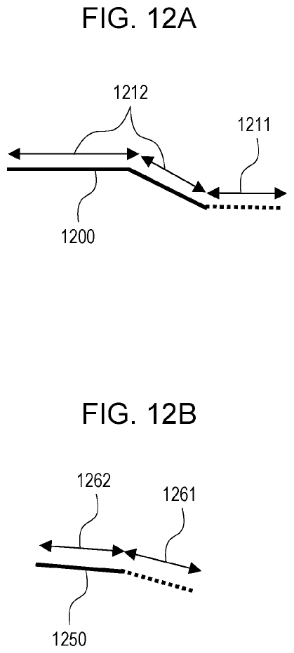

FIG. 12A and FIG. 12B are diagrams illustrating example cracks present on the same examination target image. A crack 1200 illustrated in FIG. 12A and a crack 1250 illustrated in FIG. 12B are example cracks present on the same examination target image and represent the second defect data. The crack 1200 illustrated in FIG. 12A is formed of, for example, a new crack portion 1211 (dotted line) having a length of 4 mm and an existing crack portion 1212 (solid line) having a length of 10 mm. The crack 1250 illustrated in FIG. 12B is formed of, for example, a new crack portion 1261 (dotted line) having a length of 4 mm and an existing crack portion 1262 (solid line) having a length of 5 mm Although the line length of the new crack portion of the crack 1200 and the line length of the new crack portion of the crack 1250 are the same, the proportion of the new crack portion to the crack 1200 is about 29% (= 4/14), and the proportion of the new crack portion to the crack 1250 is about 44% (= 4/9). In this case, the crack 1250 illustrated in FIG. 12B in which the proportion of the developing crack is high has a higher degree of development (development rate), and therefore, the information processing apparatus changes a coefficient for the crack having a higher degree of development (development rate) to increase the priority level.

As described above, in the fourth modification, in a case where the amounts of development of defects (in the above example, the line lengths of the new crack portions) are the same but the degrees of development of the defects are different, an index for priority level calculation is changed on the basis of the degree of development.

In the above example, although an example of a line segment length has been described, the information processing apparatus may calculate the degree of development (development rate) of a defect by using the difference value between an existing width and a developing width, the difference value between an existing area and a developing area, or other difference values. Instead of using the degree of development (proportion or rate) of a single defect, a plurality of degrees of development may be used. A combination of the amount of development of a defect and the degree of development of the defect may be used.

### Second Embodiment

In the first embodiment, a configuration has been described in which a screen showing developing defects is displayed and one operator responsible for investigation and inspection performs checking (visual checking) from region to region. In a second embodiment, an example configuration in which information about developing defects is stored on a server and distributed to a plurality of information processing apparatuses that are client terminals to thereby allow a plurality of operators to perform a check process will be described.

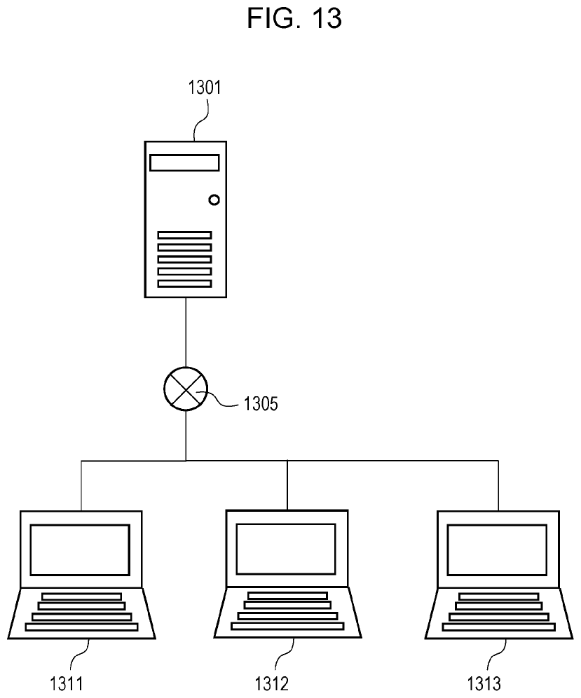

FIG. 13 is a diagram illustrating an example system configuration according to the second embodiment. The system configuration illustrated in FIG. 13 is constituted by a server 1301 and a plurality of information processing apparatuses 1311 to 1313, which are connected to each other via, for example, a network 1305 so as to enable communication. Although FIG. 13 illustrates an example where the number of information processing apparatuses is three, the number is not limited to three. It is assumed that the hardware configuration of the server 1301 and that of the information processing apparatuses 1311 to 1313 are the same as the hardware configuration described with reference to FIG. 1.

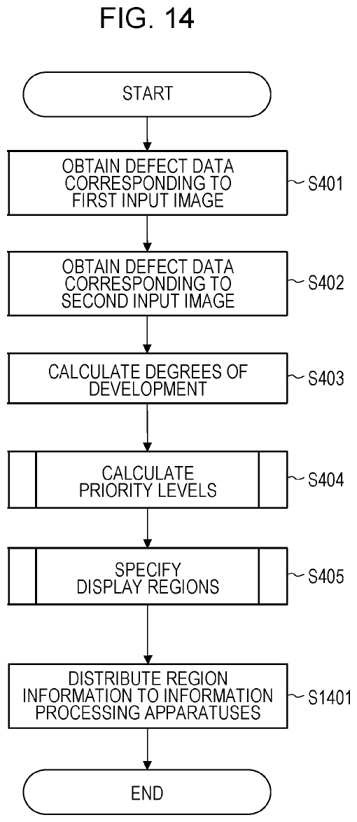

FIG. 14 is a flowchart illustrating a flow of information processing in the server 1301. A process the same as that performed by the information processing apparatus 100 according to the first embodiment is assigned the same reference numeral, and a description thereof is omitted.

In S1401, the CPU 101 of the server 1301 divides the region table 901, as illustrated in FIG. 9A, specified and generated in S405, in accordance with the number of information processing apparatuses and distributes the divided tables to the information processing apparatuses via the communication unit 107. When the region table 901 is divided, region IDs in the region table 901 are separated in accordance with the number of information processing apparatuses. For example, in a case where the number of information processing apparatuses that are client terminals is three as illustrated in FIG. 13 and the number of region IDs in the region table 901 is 90, the CPU 101 of the server 1301 divides the region table 901 into three tables each including 30 region IDs. The server 1301 transmits a region table including 30 region IDs to the information processing apparatus 1311, a region table including the subsequent 30 region IDs to the information processing apparatus 1312, and a region table including the remaining 30 region IDs to the information processing apparatus 1313.

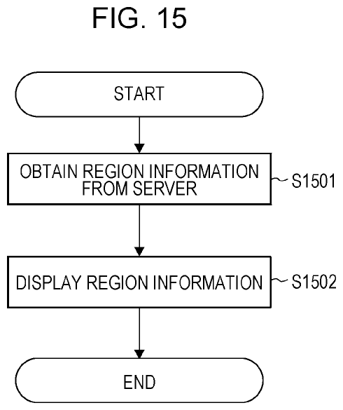

FIG. 15 is a flowchart illustrating a flow of information processing in the information processing apparatus 1311. Similar information processing is performed also in the information processing apparatuses 1312 and 1313.

In S1501, the CPU 101 of the information processing apparatus 1311 obtains information about the region table transmitted from the server 1301 via the communication unit 107.

Next, in S1502, the CPU 101 of the information processing apparatus 1311 displays check target regions as in S406 in FIG. 4 on the basis of the region table obtained in S1501. Accordingly, the operator using the information processing apparatus 1311 can perform checking.

In the second embodiment, the processes performed within the information processing apparatus in the first embodiment are separated and performed by the server and the client terminals. Therefore, according to the second embodiment, a large number of regions of developing defects can be checked separately by a plurality of operators responsible for investigation and inspection, and the time taken for the check operation can be reduced.

Regarding the method for registering the first defect data and the second defect data on the server, registration may be performed in the server or may be performed from any of the client terminals to the server.

Although an example has been described where in S1401, the region table is simply divided equally into tables each including a predetermined number of region IDs, allocation at the time of division may be changed in accordance with the priority levels of developing defects. For example, in a case where the level of skill differs among the operators responsible for investigation and inspection, an operator having a high level of skill may be assigned the region ID of a region including a defect having a high priority level, and an operator having a low level of skill may be assigned the region ID of a region including a defect having a low priority level. Accordingly, operators responsible for investigation and inspection having different levels of skill can be assigned in accordance with the priority levels, and developing defects can be checked efficiently.

As described above, the information processing apparatus according to the first and second embodiments can calculate the priority levels in accordance with the degrees of importance of developing defects and change the method for displaying regions that include developing defects. That is, the information processing apparatus according to the first and second embodiments calculates the priority levels of regions that include developing defects and changes a region including a defect to be displayed on the basis of the calculated priority levels. Accordingly, the operator responsible for investigation and inspection can efficiently inspect (check) a defect to be preferentially checked.

Some embodiments can be implemented as a process in which a program that implements one or more functions of the above-described embodiments is supplied to a system or an apparatus via a network or a storage medium and one or more processors of a computer in the system or the apparatus reads and executes the program. Some embodiments can be also implemented as a circuit (for example, an application-specific integrated circuit (ASIC)) that implements one or more functions.

Any of the above-described embodiments is a specific example for implementing the present disclosure and should not be used to construe the technical scope of the present disclosure in a limited manner.

That is, the present disclosure can be implemented in various forms without departing from the technical spirit or major features thereof.

According to the present disclosure, the possibility of the operator overlooking a defect that is to be checked can be reduced.

### Other Embodiments

Some embodiment(s) can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has described exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2021-040480, filed on Mar. 12, 2021, which is hereby incorporated by reference herein in its entirety.

What is claimed is:

1. An information processing apparatus comprising:
an obtaining unit configured to obtain pieces of defect data respectively extracted from a plurality of images captured at different times;
a detection unit configured to detect developing defects on the basis of differences between the pieces of defect data extracted from the images captured at the different times;
a calculation unit configured to calculate priority levels of the defects on the basis of the differences between the pieces of defect data;
a specifying unit configured to specify regions that cover the developing defects; and
a display unit configured to display the specified regions in accordance with the priority levels.

2. An information processing apparatus comprising:
a first apparatus and a second apparatus connected to each other so as to enable communication, wherein
the first apparatus includes:
an obtaining unit configured to obtain pieces of defect data respectively extracted from a plurality of images captured at different times,
a detection unit configured to detect developing defects on the basis of differences between the pieces of defect data extracted from the images captured at the different times,
a calculation unit configured to calculate priority levels of the defects on the basis of the differences between the pieces of defect data, and
a specifying unit configured to specify regions that cover the developing defects, and
the second apparatus includes:
a display unit configured to display the regions specified by the first apparatus, in accordance with the priority levels.

3. The information processing apparatus according to claim 2, wherein
the second apparatus includes two or more second apparatuses, and
the first apparatus separates the plurality of specified regions into groups of regions that respectively correspond to the two or more second apparatuses and distributes each of the groups of regions to a corresponding one of the second apparatuses.

4. The information processing apparatus according to claim 1, wherein
the specifying unit is configured to specify the regions on the basis of a display resolution with which an operator is able to visually check the defects.

5. The information processing apparatus according to claim 1, wherein
the calculation unit is configured to make a calculation reference for the priority levels differ in accordance with types of the defects extracted from the images.

6. The information processing apparatus according to claim 1, wherein
the calculation unit further includes a change unit configured to change a calculation reference for the priority levels on the basis of an instruction from an operator.

7. The information processing apparatus according to claim 1, wherein
the calculation unit is configured to calculate the priority levels on the basis of degrees of development of the defects.

8. The information processing apparatus according to claim 1, wherein
the display unit is configured to display the specified regions in an order according to the priority levels.

9. The information processing apparatus according to claim 8, wherein
the display unit is configured to display a user interface via which an operator changes the order of display according to the priority levels.

10. The information processing apparatus according to claim 1, wherein
the display unit is configured to superimpose and display each of the pieces of defect data on an image.

11. The information processing apparatus according to claim 1, wherein
the calculation unit is configured to calculate the priority levels on the basis of information indicating an attribute of a structure on which the defects appear.

12. The information processing apparatus according to claim 2, wherein
the specifying unit is configured to specify the regions on the basis of a display resolution with which an operator is able to visually check the defects.

13. The information processing apparatus according to claim 2, wherein
the calculation unit is configured to make a calculation reference for the priority levels differ in accordance with types of the defects extracted from the images.

14. The information processing apparatus according to claim 2, wherein
the calculation unit further includes a change unit configured to change a calculation reference for the priority levels on the basis of an instruction from an operator.

15. The information processing apparatus according to claim 2, wherein
the calculation unit is configured to calculate the priority levels on the basis of degrees of development of the defects.

16. The information processing apparatus according to claim 2, wherein
the display unit is configured to display the specified regions in an order according to the priority levels.

17. The information processing apparatus according to claim 16, wherein
the display unit is configured to display a user interface via which an operator changes the order of display according to the priority levels.

18. The information processing apparatus according to claim 2, wherein
the display unit is configured to superimpose and display each of the pieces of defect data on an image.

19. The information processing apparatus according to claim 2, wherein
the calculation unit is configured to calculate the priority levels on the basis of information indicating an attribute of a structure on which the defects appear.

20. An information processing method to be performed by an information processing apparatus, the information processing method comprising:
an obtaining step of obtaining pieces of defect data respectively extracted from a plurality of images captured at different times;
a detection step of detecting developing defects on the basis of differences between the pieces of defect data extracted from the images captured at the different times;
a calculation step of calculating priority levels of the defects on the basis of the differences between the pieces of defect data;
a specifying step of specifying regions that cover the developing defects; and
a display step of displaying the specified regions in accordance with the priority levels.

21. An information processing method to be performed by an information processing apparatus including a first apparatus and a second apparatus connected to each other so as to enable communication, the information processing method comprising:
an obtaining step, by the first apparatus, of obtaining pieces of defect data respectively extracted from a plurality of images captured at different times;
a detection step, by the first apparatus, of detecting developing defects on the basis of differences between the pieces of defect data extracted from the images captured at the different times;
a calculation step, by the first apparatus, of calculating priority levels of the defects on the basis of the differences between the pieces of defect data;
a specifying step, by the first apparatus, of specifying regions that cover the developing defects; and
a display step, by the second apparatus, of displaying the regions specified by the first apparatus, in accordance with the priority levels.

22. A non-transitory computer-readable storage medium storing a program for causing a computer to execute an information processing method, the information processing method comprising:
an obtaining step of obtaining pieces of defect data respectively extracted from a plurality of images captured at different times;
a detection step of detecting developing defects on the basis of differences between the pieces of defect data extracted from the images captured at the different times;
a calculation step of calculating priority levels of the defects on the basis of the differences between the pieces of defect data;
a specifying step of specifying regions that cover the developing defects; and
a display step of displaying the specified regions in accordance with the priority levels.
